(19) United States
(12) Patent Application Publication
(10) Pub. No.: US 2008/0239023 A1
(43) Pub. Date: Oct. 2, 2008

(54) LIQUID EJECTING HEAD

(75) Inventor: Noriaki Okazawa, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/056,081

(22) Filed: Mar. 26, 2008

(30) Foreign Application Priority Data
Mar. 27, 2007 (JP) 2007-082766

(51) Int. Cl. B41J 2/045

(52) U.S. Cl. 347/71

(57) ABSTRACT

A liquid ejecting head includes a flow passage unit, a vibrator unit, a case unit, and a common base substrate. The flow passage unit includes a liquid flow passage and a diaphragm portion. The liquid flow passage at least includes a pressure chamber that communicates with a nozzle opening. The diaphragm portion varies a volume of the pressure chamber. The vibrator unit inlucdes a piezoelectric vibrator that displaces the diaphragm portion. The case unit accommodates the vibrator unit. The common base substrate connects a plurality of pairs of the case unit and the flow passage unit. The common base substrate is fixed between the plurality of pairs of the case unit and the flow passage unit.

### BACKGROUND

1. Technical Field

The present invention relates to a liquid ejecting head, such as an ink jet recording head, and more particularly to a liquid ejecting head that is provided with a plurality of flow passage units, each of which forms a continuous liquid flow passage extending from a common liquid chamber through pressure chambers to nozzle openings, and that is able to discharge liquid from the nozzle openings of each flow passage unit as liquid droplets.

2. Related Art

A liquid ejecting head that discharges liquid droplets from nozzle openings by generating pressure variation in the liquid contained in pressure chambers, for example, includes an ink jet recording head used for an image recording apparatus, such as a printer, a color material ejecting head used for manufacturing a color filter for a liquid crystal display, or the like, an electrode material ejecting head used for forming an electrode for an organic electro luminescence (EL) display, a field emission display (FED), or the like, and a bio-organic material ejecting head used for manufacturing a biochip, or the like.

The above described liquid ejecting heads have various types; however, for example, the ink jet recording head (hereinafter, referred to as recording head) used in an ink jet recording apparatus (hereinafter, simply referred to as printer) includes a flow passage unit that is formed by laminating a nozzle substrate, a flow passage substrate, and an elastic plate. The nozzle substrate has a plurality of nozzle openings formed therein. The flow passage substrate forms a flow passage portion, such as a pressure chamber space portion and a channel portion, which define a continuous ink flow passage extending from a common ink chamber through pressure chambers to the nozzle openings. The elastic plate has diaphragm portions, each of which faces the pressure chamber and elastically deforms in accordance with the action of a pressure generating device (for example, a piezoelectric vibrator) (which may be regarded as a sealing plate that seals the opening of the flow passage substrate). Then, the flow passage unit is fixed to a case unit. The recording head needs to have a high processing density and a high processing accuracy in response to a high-density recording image and/or a high-speed recording operation. Therefore, for example, the flow passage substrate is formed in such a manner that a microscopic shape is formed with high dimension accuracy by performing anisotropic etching on a crystalline substrate material, such as a silicon monocrystalline base material (silicon wafer).

Some of the recording heads are formed so that a pair of flow passage unit and case unit form a head unit and then a plurality of the head units are arranged in a line and assembled. In this recording head, it is, of course, important to accurately position and assemble the component members of the flow passage unit and case unit, which form each of the head units, and it is also important to accurately position and assemble the head units each other. Therefore, there is a technology in which a portion, which serves as a positioning reference, is provided for a member on which the plurality of head units are mounted, and each of the head units is urged by a spring provided on a cover member that protects the entire recording head to thereby position the head units and protect the entire recording head, which is, for example, described in JP-A-5-16339.

However, in the above recording head, the outer portion of each head unit is urged to a portion, which serves as a positioning reference of a component made of synthetic resin, and is positioned by being pressed to the portion, so that many components are present between the nozzle position and the outer portion of each head unit. Thus, the assembling accuracy of these components influences the outer portion and, as a result, it is difficult to ensure positioning accuracy. In addition, when there are many components made of synthetic resin, sufficient positioning accuracy cannot be expected.

### SUMMARY

An advantage of some aspects of the invention is that it provides a liquid ejecting head that allows a plurality of head units to be positioned and assembled with high accuracy.

An aspect of the invention provides a liquid ejecting head. The liquid ejecting head includes a flow passage unit, a vibrator unit, a case unit, and a common base substrate. The flow passage unit includes a liquid flow passage and a diaphragm portion. The liquid flow passage at least includes a pressure chamber that communicates with a nozzle opening. The diaphragm portion varies a volume of the pressure chamber. The vibrator unit includes a piezoelectric vibrator that displaces the diaphragm portion. The case unit accommodates the vibrator unit. The common base substrate connects a plurality of pairs of the case unit and the flow passage unit. The common base substrate is fixed between the plurality of pairs of the case unit and the flow passage unit.

According to the above configuration, the common base substrate is fixed between the plurality of pairs of the case unit and the flow passage unit, both of which constitute the liquid ejecting head, and the common substrate connects the plurality of pairs of the case unit and the flow passage unit. Thus, it is possible to position and assemble a plurality of units using the common base substrate as a reference. As a result, in comparison with the case in which positioning is made at the outer portion of the case unit, it is possible to perform positioning with a component located adjacent to the nozzle opening and thereby it is possible to perform positioning and then perform assembling with high accuracy. In addition, the case unit and the flow passage unit, which form each head unit, are assembled on both sides with respect to the common base substrate to thereby perform positioning with high accuracy.

In addition, the aspect of the invention may be configured so that the common base substrate has at least two reference positioning holes that position a corresponding one of the pairs of the case unit and the flow passage unit, wherein each of the case unit and the flow passage unit is fixed at positions corresponding to the at least two reference positioning holes.

According to the above configuration, each of the case unit and the flow passage unit is positioned using at least two reference positioning holes of the common base substrate. Thus, it is possible to position each unit on the plane of the common base substrate. As a result, it is possible to perform positioning with the component located adjacent to the nozzle opening and then assemble with high accuracy. Incidentally, the aspect of the invention may be configured so that positioning holes of the case unit overlap positioning holes of the flow passage unit. Thus, by overlapping the positioning holes of the case unit with the positioning holes of the flow passage unit, it is possible to simply perform positioning.

In addition, the aspect of the invention may be configured so that the common base substrate is formed of a silicon substrate. In this manner, it is possible to form the common base substrate with high accuracy by performing an etching process on the silicon substrate, and also possible to form each reference positioning hole with high accuracy.

In addition, the aspect of the invention may be configured so that the thickness of the common base substrate is set smaller than the length of a free end portion of each piezoelectric vibrator.

According to the above configuration, because the thickness of the common base substrate, which is fixed between the plurality of pairs of the case unit and the flow passage unit, is set smaller than the length of the free end portion of the piezoelectric vibrator, it is possible to arrange the common base substrate without changing the length of flow passage in the flow passage unit to the piezoelectric vibrator and to the nozzle opening. In this manner, without changing the discharge characteristics, it is possible to assemble the units in a state where they are positioned with high accuracy.

In addition, the aspect of the invention may be configured so that the common base substrate has insertion opening portions, each of which is located at a position corresponding to the diaphragm portion of each flow passage unit, wherein a free end portion of each piezoelectric vibrator is insertable through each insertion opening portion.

According to the above configuration, the free end portion of the piezoelectric vibrator located at a position corresponding to the diaphragm portion of the flow passage unit is inserted into the insertion opening portion formed in the common base substrate. Thus, without interfering with the piezoelectric vibrator, it is possible to arrange the common base substrate and also possible to reinforce the surrounding of the diaphragm portion to thereby enhance the rigidity. In this manner, it is possible to improve the positioning accuracy, while, at the same time, it is possible to obtain the discharge with high response frequency and/or uniform discharge characteristics.

In addition, the aspect of the invention may be configured so that each flow passage unit has a plurality of the diaphragm portions that are provided in a column in correspondence with a plurality of the pressure chambers, respectively, wherein the common base substrate has insertion opening portions, each of which is common to all the diaphragm portions in the same column in correspondence with each column of the diaphragm portions of each flow passage unit. Furthermore, the common base substrate may be configured to have a plurality of insertion opening portions in a one to one correspondence with each of the diaphragm portions of each flow passage unit. Moreover, the common base substrate may be configured to have a plurality of insertion opening portions, each of which is common to and in correspondence with a plurality of the diaphragm portions that are located adjacent to one another in each flow passage unit.

According to the above configuration, with respect to the insertion opening portions of the common base substrate, the insertion opening portion that is common to all the diaphragm portions in the same column in correspondence with each column of the diaphragm portions that constitute the diaphragm portions of each flow passage unit, or the insertion opening portions each are formed in a one to one correspondence with each of the diaphragm portions, or the insertion opening portions, each of which is common to a plurality of the adjacent diaphragm portions, are formed. Thus, without interfering with the piezoelectric vibrators, it is possible to arrange the common base substrate and also possible to reinforce the surrounding of the diaphragm portions with the insertion opening portions having the respective sizes to thereby enhance the rigidity. Moreover, when the insertion opening portion is reduced to the insertion opening portion having a size corresponding to the size of one piezoelectric vibrator, it is possible to further enhance the rigidity and uniformly reinforce the surrounding of the diaphragm portions.

### BRIEF DESCRIPTION OF THE DRAWINGS

The invention will be described with reference to the accompanying drawings, wherein like numbers reference like elements.

FIG. 1 is a perspective view that illustrates the configuration of a printer.

FIG. 2 is a cross-sectional view of a relevant portion, illustrating the configuration of a recording head.

FIG. 3 is a longitudinal cross-sectional view of a relevant portion, illustrating the configuration of the recording head.

FIG. 4 is an exploded perspective view of a flow passage unit, a common base substrate and a case unit.

FIG. 5 is a plan view of the common base substrate.

FIG. 6A and FIG. 6B are views, each of which illustrates a reference hole.

FIG. 7 is an exploded perspective view of a flow passage unit, a common base substrate and a case unit.

FIG. 8 is a plan view of the common base substrate.

FIG. 9 is a longitudinal cross-sectional view of a relevant portion, illustrating the configuration of the recording head.

FIG. 10 is an exploded perspective view of a flow passage unit, a common base substrate and a case unit.

FIG. 11 is a longitudinal cross-sectional view of a relevant portion, illustrating the configuration of the recording head.

FIG. 12A and FIG. 12B are plan views, each of which illustrates variations of layouts of head units.

FIG. 13 is a plan view that shows an alternative embodiment of a common base substrate.

### DESCRIPTION OF EXEMPLARY EMBODIMENTS

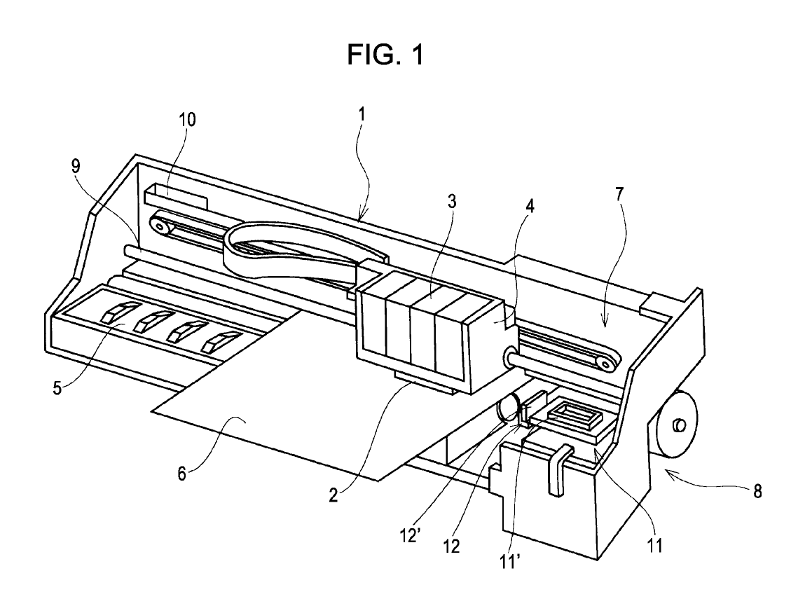

Hereinafter, embodiments of the invention according to the invention will be described with reference to the accompanying drawings. Note that, in the embodiments described below, various limitations are made as desirable specific embodiments of the aspects of the invention; however, the scope of the invention is not intended to be limited to these embodiments unless otherwise expressly stated in the description to the effect that the invention is limited. In addition, in the following description, an ink jet printer (hereinafter, simply referred to as printer) shown in FIG. 1 is exemplified as an apparatus to which a liquid ejecting head according to the aspects of the invention is applied.

The printer 1 has an installed recording head 2, which is a kind of the liquid ejecting head according to the aspects of the invention, and schematically includes a carriage 4, a platen 5, a carriage moving mechanism 7, a paper feed mechanism 8, and the like. An ink cartridge 3 is detachably mounted on the carriage 4. The platen 5 is arranged below the recording head 2. The carriage moving mechanism 7 moves the carriage 4, on which the recording head 2 is mounted, in a paper width direction of a sheet of recording paper 6 (a kind of discharged object). The paper feed mechanism 8 transports the sheet of recording paper 6 in a paper feed direction which is a direction perpendicular to the paper width direction. Here, the paper width direction is a main scanning direction (head scanning direction), and the paper feed direction is a sub scanning direction (that is, a direction perpendicular to the head scanning direction). Note that the ink cartridge 3 may employ a type that is attached to the carriage 4 or may employ a type that is attached to the case of the printer 1 and supplies the recording head 2 through an ink supply tube.

The carriage 4 is mounted so that it is pivotally connected to a guide rod 9 that extends in the main scanning direction. The carriage 4 is configured to move in the main scanning direction along the guide rod 9 by the action of the carriage moving mechanism 7. The position of the carriage 4 in the main scanning direction is detected by a linear encoder 10, and a detection signal is transmitted to a control portion (not shown) as positional information. In this manner, the control portion is able to recognize a scanning position of the carriage 4 (recording head 2) on the basis of the positional information from the linear encoder 10 and control a recording operation (discharging or ejecting operation), or the like, performed by the recording head 2.

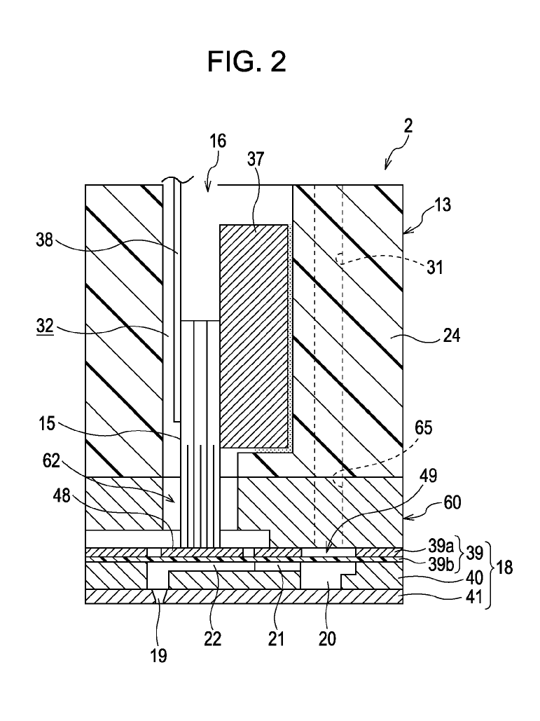

In addition, a home position, which is a scanning start point (rest position when no recording is performed) of the recording head 2, is set within a movable range of the recording head 2 and outside the platen 5. At this home position, a capping mechanism 11 is provided. The capping mechanism 11 seals the nozzle forming face of the recording head 2 by a cap member 11′ to thereby prevent vaporization of ink solvent from nozzle openings 19 (see FIG. 2). In addition, the capping mechanism 11 is used for a cleaning operation in which a negative pressure is applied to a sealed nozzle face to thereby forcibly sucks and drains ink from the nozzle openings 19.

In addition, at the home position, a wiping mechanism 12 that wipes the nozzle forming face of the recording head 2 is arranged. The wiping mechanism 12 is provided with a wiper blade 12′, which is, for example, formed of an elastic material, such as elastomer. The wiping mechanism 12 is configured so that, when the recording head 2 passes over the wiping mechanism 12, the upper end portion of the wiper blade 12′ moves to a position (wiping position) at which the upper end portion of the wiper blade 12′ is able to contact the nozzle forming face of the recording head 2. Then, when the recording head 2 moves in a state where the upper end portion of the wiper blade 12′ is in contact with the nozzle forming face of the recording head 2, the nozzle forming face of the recording head 2 is wiped by the wiper blade 12′. In this manner, it is possible to remove, for example, redundant ink droplets adhered on the nozzle forming face after cleaning operation.

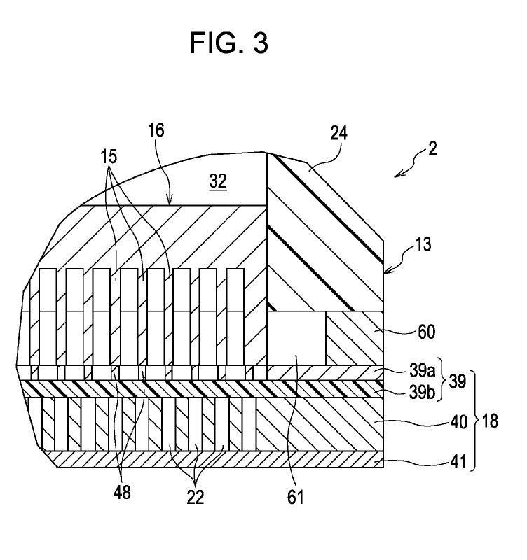

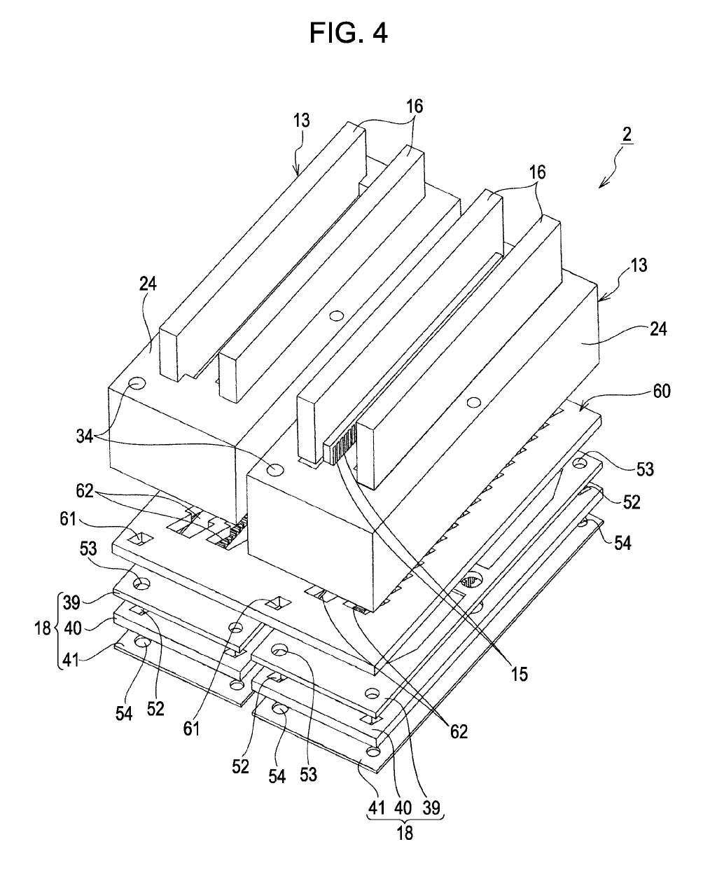

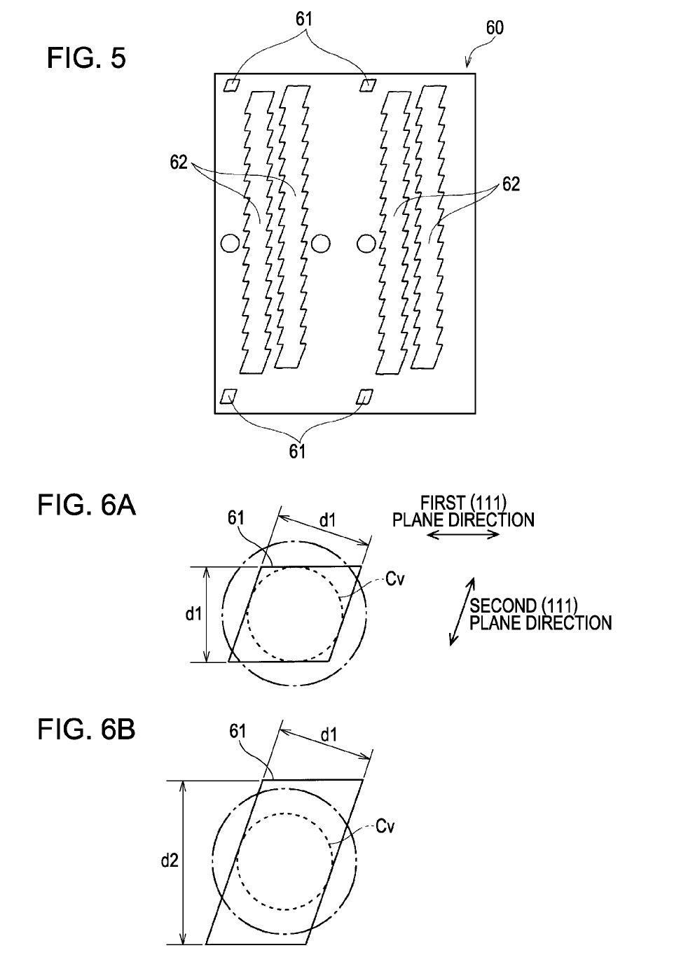

FIG. 2 is a cross-sectional view of a relevant portion, illustrating the configuration of the recording head 2. FIG. 3 is a longitudinal cross-sectional view of a relevant portion, illustrating the configuration of the recording head 2. FIG. 4 is an exploded perspective view of the recording head 2 that includes two head units 13. FIG. 5 is a plan view of a common base substrate. The recording head 2 according to the present embodiment schematically includes two head units 13, each of which includes vibrator units 16 that each having a plurality of piezoelectric vibrators 15, a flow passage unit 18 that forms a continuous ink flow passage (a kind of liquid flow passage) that extends from a common ink chamber 20 (common liquid chamber) through ink supply ports 21 and pressure chambers 22 to the nozzle openings 19, a case unit 24, and the like.

Each of the case units 24 is a hollow box-shaped casing, and has case flow passages 31, which are formed therein, and accommodation chambers 32. The case flow passage 31 each are a flow passage for introducing ink from the ink cartridge 3 toward the common ink chamber 20. The accommodation chambers 32 each separately accommodates each of the vibrator units 16. The case unit 24 is formed of epoxy resin, which is a kind of thermosetting resin, and the flow passage unit 18 is fixed to the flow passage fitting face of the case unit 24. In addition, each case unit 24 has two pin retaining portions 34 (which also serve as positioning holes) that are formed therein along the long side and that extend through in the height direction of the case, as shown in FIG. 4 (in FIG. 4, only one of two pin retaining portions 34 is shown in each case unit 24). These pin retaining portions 34 are space portions for respectively retaining case pins (not shown), and each are formed into a cylindrical shape of which an inner diameter is slightly larger than the diameter of the case pin. In the present embodiment, the two pin retaining portions 34 are respectively provided at positions corresponding to reference holes 52 (see FIG. 4) that are formed in the flow passage substrate 40. Then, each case pin is implanted into the corresponding pin retaining portion 34 and is retained in a state where the distal end portion protrudes from the flow passage fitting face. Positioning may be performed by matching the diameter of each case pin to the diameter of the inscribed circle of each reference hole 52. Note that positioning of the flow passage unit 18 with the case unit 24 will be described later.

Each of the above vibrator units 16 includes the piezoelectric vibrators 15, a fixed plate 37 to which these piezoelectric vibrators 15 are connected, flexible cables 38 for supplying driving signals from a wiring substrate to the piezoelectric vibrators 15, and the like. Each piezoelectric vibrator 15 is connected to the fixed plate 37, which is formed of a metal plate material, such as stainless steel, in a state of a so-called cantilever such that a free end portion of the piezoelectric vibrator 15 protrudes outside the distal end face of the fixed plate 37. Note that the pressure generating device may employ an electrostatic actuator, a magnetostrictive element, a heater element, or the like, other than the above piezoelectric vibrator.

Each of the flow passage units 18 is formed so that a lamination of flow passage unit components, composed of a diaphragm 39, a flow passage substrate 40 and a nozzle substrate 41, is bonded and integrated. The pressure chambers 22 of each flow passage unit 18 are formed as long narrow chambers extending in a direction perpendicular to a column array direction (nozzle array direction) of the nozzle openings 19. In addition, the common ink chamber 20 is a chamber into which ink is introduced from the side of an ink introducing needle. Then, ink introduced into the common ink chamber 20 is separately supplied through the ink supply ports 21 to the pressure chambers 22.

The nozzle substrate 41 that is arranged at the bottom of the flow passage unit 18 is a metal thin plate material in which the plurality of nozzle openings 19 are formed in a column in the sub scanning direction at a pitch corresponding to the density of dot formation. The nozzle substrate 41 of the present embodiment is formed of a stainless plate material, and a plurality of the columns (nozzle columns) of the nozzle openings 19 are provided and aligned along the scanning direction (main scanning direction) of the recording head 2. Then, one nozzle column is, for example, formed of 180 nozzle openings 19.

The flow passage substrate 40 in the present embodiment is a plate-like member in which a flow passage portion that forms ink flow passages, that is, specifically, an opening portion that serves as the common ink chamber 20, channel portions that serve as the ink supply ports 21 and pressure chamber space portions that serve as the pressure chambers 22 are defined. The flow passage substrate 40 is formed by performing anisotropic etching on a silicon wafer, which is a kind of crystalline base material.

The above diaphragm 39 is, as shown in FIG. 2, a double layer structure composite plate material in which an elastic film 39b, such as a PPS resin, is laminated on a support plate 39a made of metal, such as stainless steel. In the diaphragm 39, island portions 48 for bonding the distal ends of the free end portions of the piezoelectric vibrators 15 are formed at portions corresponding to the pressure chambers 22, and the thus formed portions function as diaphragm portions. That is, the diaphragm 39 is configured so that elastic films around the island portions 48 elastically deform in accordance with the action of the piezoelectric vibrators 15. In addition, the diaphragm 39 seals the open portion of the common ink chamber 20 of the flow passage substrate 40 and also serves as a compliance portion 49 as well. A portion of the diaphragm 39 corresponding to the compliance portion 49 is only formed of the elastic film 39b by removing the support plate 39a. Note that the diaphragm 39 may be regarded as a sealing plate that seals the opening face of the flow passage portion 43 formed in the flow passage substrate 40.

Here, in each of the above flow passage substrates 40, four reference holes 52 in total for specifying the relative position with the diaphragm 39, the nozzle substrate 42 and the case unit 24 are formed in a frame region, which is a region located outside the region in which the flow passage portion 43 is formed (flow passage portion forming region), as shown in FIG. 4 (in FIG. 4, a portion of the four reference holes 52 are shown). Then, the spaced apart two reference holes 52 located on one long side (left side) are reference holes that are used when the flow passage unit 18 and the case unit 24 are positioned, while, on the other hand, the two reference holes 52 located on the other long side (right side) are reference holes that are used when the components of the flow passage unit 18 are positioned. In this manner, by using two reference holes, which are used as a reference when positioning, that are located on any one of the long sides and that are spaced apart in long distance from each other, it is attempted to improve the positioning accuracy.

On the other hand, as shown in FIG. 4, in each of the diaphragms 39 and each of the nozzle substrates 41, four through holes 53 and four through holes 54 are respectively formed at positions corresponding to the reference holes 52 of the flow passage substrate 40 (in FIG. 4, a portion of the four through holes 53 and four through holes 54 are shown). Then, when these component members of the flow passage unit are bonded, the component members are sequentially laminated on a jig.

In the present embodiment, first, in a state where positioning pins provided on the jig are respectively inserted into the through holes 54 on the other long side, the nozzle substrate 41 is laminated on a flow passage unit mounting face of the jig. Subsequently, the positioning pins are respectively inserted into the reference holes 52 on the other long side, and, in a state where an adhesive is interposed in between, the flow passage substrate 40 is mounted on the nozzle substrate 41. Then, the positioning pins are respectively inserted into the through holes 53 on the other side, and, in a state where an adhesive is interposed in between, the diaphragm 39 is mounted on the flow passage substrate 40.

In this manner, the nozzle substrate 41, the flow passage substrate 40 and the diaphragm 39 are bonded one another in a state where their relative positions are specified, so that the flow passage unit 18 is assembled.

In this recording head 2, a common base substrate 60, which is a single piece of plate-like material, is interposed between the two pairs of case unit 24 and flow passage unit 18, which form two head units 13. In the common base substrate 60, four reference positioning holes 61 corresponding to the pin retaining portions 34 of the two head units 13 are formed. In addition, in the common base substrate 60, insertion opening portions 62, each of which is common to all the island portions 48 in the same column, are formed. The island portions 48, which serve as diaphragm portions, are provided in a column in a one to one correspondence with the plurality of pressure chambers 22. That is, four columns of insertion opening portions 62 are formed in the common base substrate 60 in correspondence with two columns of vibrator units 16 that are contained in each of the head units 13, and the free end portions of the piezoelectric vibrators 15 are insertable through the insertion opening portions 62. In addition, the thickness of the common base substrate 60 is set smaller than the length of the free end portion of each piezoelectric vibrator 15. In this manner, the free end portions of the piezoelectric vibrators 15, in a state where they are interposed between the case unit 24 and the flow passage unit 18, are inserted into the insertion opening portions 62, and then the distal end portions of the piezoelectric vibrators 15 may be closely adhered and bonded to the island portions 48 of the diaphragms 39. In addition, communication flow passages 65 are formed in the common base substrate 60 in correspondence with the case flow passages 31.

The reference positioning holes 61 of the common base substrate 60, as shown in FIG. 4 and FIG. 5, are formed at positions so as to overlap in correspondence with the reference holes 52 of the flow passage substrate 40 of the flow passage unit 18 of each head unit 13 and the pin retaining portions 34 of each case unit 24. That is, the four reference positioning holes 61 are formed two by two in parallel with the long side of each head unit 13. In the common base substrate 60 in the present embodiment, the reference positioning holes 61 and the insertion opening portions 62, through which the free end portions of the piezoelectric vibrators 15 are inserted, are formed by performing anisotropic etching process on a silicon substrate (silicon wafer), which is a kind of crystalline base material. In this manner, the processing accuracy is improved to thereby make it possible to improve the positioning accuracy.

At least one of the two reference positioning holes 61 corresponding to each head unit 13 is formed in a polygonal shape having equal length of sides such that, as shown in FIG. 6A, the polygonal shape is formed of, on the surface (110) plane of the silicon wafer of the common base substrate 60, a first (111) plane that is perpendicular to the surface (110) plane and a second (111) plane that obliquely intersects with the first (111) plane at an angle of 70.53 degrees and that is perpendicular to the surface of the silicon wafer. In the present embodiment, the reference positioning holes 61 are formed in a rhombic shape having four sides of equal length. The dimension of each reference positioning hole 61 is determined so that a perpendicular distance between the opposite sides is d1. In other words, the dimension of the hole is determined so that the diameter of an imaginary inscribed circle Cv that inscribes the reference positioning hole 61 is d1. The diameter d1 of the inscribed circle Cv is made equal to the diameter of the positioning pin of the assembling jig and the diameter of the case pin of the case unit 24. That is, each reference positioning hole 61 is set to a dimension such that rattling does not occur with respect to the positioning pin and/or the case pin.

In addition, at least the other one of the two reference positioning holes 61 corresponding to each head unit 13 may be different in shape from the above reference positioning hole 61, as shown in FIG. 6B, or may have a polygonal shape having sides of different length. In the present embodiment, the other one of two reference positioning holes 61 is formed in a parallelogram oblong hole, the short side of which is defined by a first (111) plane and the long side of which is defined by a second (111) plane. The dimension of the short side of the above reference positioning hole 61 is made equal to the dimension of each side of the above described reference positioning hole 61. Specifically, the perpendicular distance between the opposite long sides is set to d1, while, on the other hand, the perpendicular distance between the opposite short sides is set to d2 that is longer than d1. Thus, when at least one of the two reference positioning holes 61 of the common base substrate 60 is formed in a rhombic shape having four sides of equal length, the remaining one may be a polygonal shape having sides of different length, for example, a parallelogram oblong hole having a short side of which the length is equal to that of the reference positioning hole 61 having a rhombic shape and a long side of which the length is different from that of the reference positioning hole 61 having a rhombic shape. Alternatively, the two reference positioning holes 61 all may be a rhombic shape.

When the common base substrate 60, the case unit 24 of one head unit 13 and the flow passage unit 18 are positioned, using the two reference positioning holes 61 of the common base substrate 60, which are arranged parallel to the long side of the head unit 13, the assembled flow passage unit 18 is bonded to the common base substrate 60 in a state where they are positioned with high accuracy and, thereafter, the case unit 24 is bonded to the common base substrate 60. Thus, it is possible to assemble one head unit 13 in a state where it is positioned with high accuracy. Similarly, by assembling the other remaining head unit 13 using the remaining two reference positioning holes 61 of the common base substrate 60, it is possible to have the two head units 13 positioned with high accuracy using the common base substrate 60 as a reference.

The head units 13 are assembled using the common base substrate 60 as follows. For example, the components of the flow passage units 18 are laminated on the jig in advance, when an adhesive between the components is hardened, the flow passage units 18 are positioned using the reference positioning holes 61 of the common base substrate 60 and then bonded. Then, these flow passage units 18 and the common base substrate 60 are removed from the jig. After that, in a state where the diaphragm side faces the case units 24, the common base substrate 60 is bonded to the flow passage fitting face of the case units 24. At this time, by inserting the case pins respectively into the reference positioning holes 61 of the common base substrate 60, the common base substrate 60 and the case units 24 are fixed in a state where their relative position is specified. Note that assembling of the head units 13 using the common base substrate 60 is not limited to the above method, but it may be modified appropriately, and it is only necessary to perform positioning using the reference positioning holes 61 of the common base substrate 60 as a reference and then perform assembling. In addition, the number of reference positioning holes 61 needs to be at least two and may be increased.

In a case where the common base substrate 60 and the flow passage units 18 of the head units 13 are positioned and when the common base substrate 60 and the case units 24 are positioned, when one of the two reference positioning holes 61 is formed as a parallelogram hole, the oblong hole resulting from the long side allows a gap to be formed between the parallelogram hole and the case pin of the case unit 24. Thus, even when there is a small tolerance, it is possible to absorb the tolerance by this gap. In this manner, without forming a crazing or a crack in the common base substrate 60 and/or the flow passage substrate 40, it is possible to perform assembling in a state where positioning is made with high accuracy.

Here, when, among the two reference positioning holes 61, one reference positioning hole 61 is formed as an oblong hole, it is elongated obliquely (second (111) plane direction). Therefore, when the center of the oblong reference positioning hole 61 is deviated from the central axis of the case pin while positioning, there is a possibility that the position of the common base substrate 60 and the flow passage unit 18 may be deviated in a rotating direction about the case pin with respect to the case unit 24. However, the positional accuracy required between the flow passage unit 18 and the case unit 24 is not as high as the positional accuracy required between the flow passage unit components, so that the above deviation in position is allowable. In addition, because the two reference positioning holes are arranged along the long side of the head unit 13 to thereby increase the distance between the two reference positioning holes, it is possible to suppress the adverse effect due to a deviation in position to a minimum degree.

In addition, in the recording head 2, the common base substrate 60 is attached to the flow passage fitting faces of the case units 24 in such a manner that the insertion opening portions 62 of the common base substrate 60 respectively surround columns of the piezoelectric vibrators 15 of the vibrator units 16. This enhances and reinforces the rigidity of the case units 24, so that it is possible to suppress compression deformation of the case units 24 or deformation of the flow passage units 18 caused by the action of the piezoelectric vibrators 15 of the vibrator units 16, which are contained and fixed in the accommodation chambers 32 of the case units 24. In this manner, it is possible to obtain the discharge with high response frequency and/or uniform discharge characteristics.

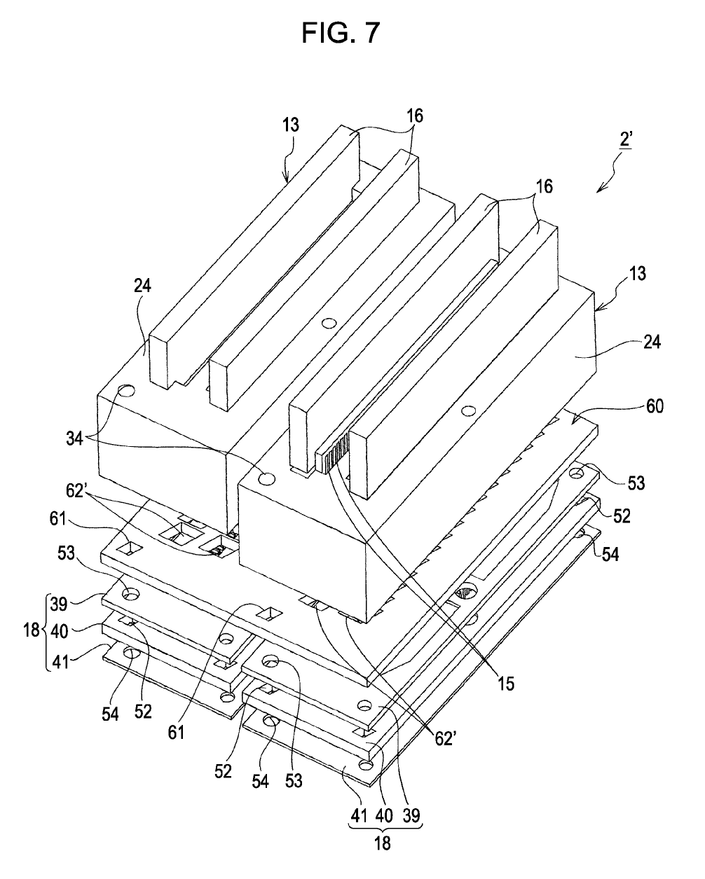

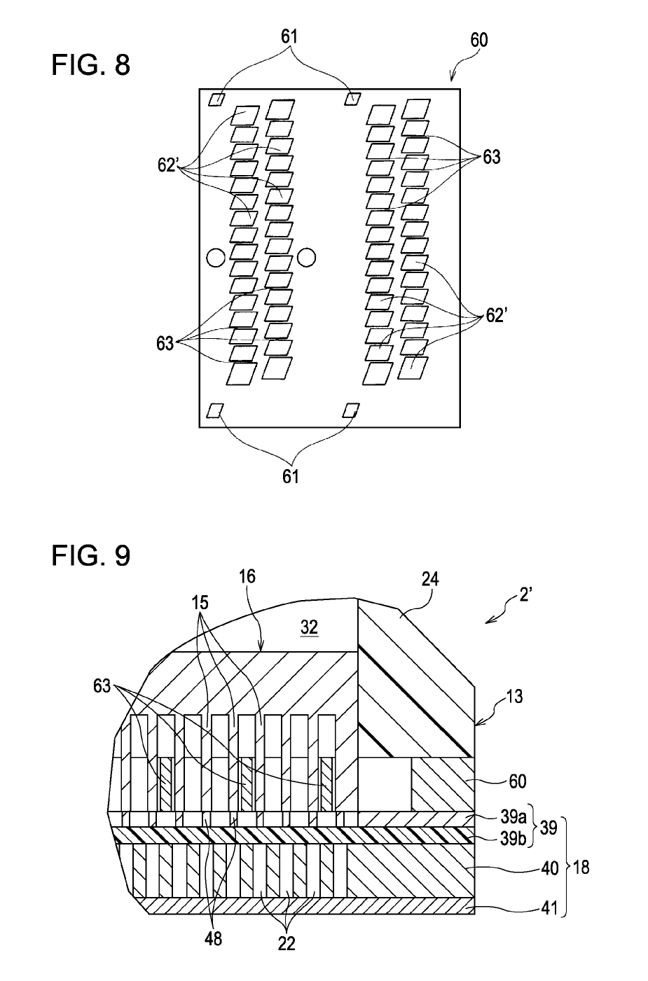

Next, another embodiment of the invention will be described with reference to FIG. 7 to FIG. 9. In the recording head 2, reinforcement obtained by enhancing the rigidity in such a manner that the common base substrate 60 is interposed between the pairs of case unit 24 and flow passage unit 18, as the size of each insertion opening portion 62 is reduced, it is possible to further suppress compression deformation of the case unit 24 and/or deformation of the flow passage unit 18. Then, in a recording head 2′, insertion opening portions 62′ of the common base substrate 60 are partitioned by crosspieces 63 with the size corresponding to a plurality of the piezoelectric vibrators 15, that is, for example, as shown in FIG. 7 to FIG. 9, with the size by which every three piezoelectric vibrators 15 are inserted, so that the rigidity of the flow passage fitting face of each case unit 24 is enhanced. Note that the other configuration is the same as that of the above described recording head 2 and, therefore, the description will not be repeated.

According to the recording head 2′, by positioning the two head units 13 using the reference positioning holes 61 of the common base substrate 60 as a reference, it is possible to position and assemble the two head units 13 with high accuracy, and by interposing the common base substrate 60 between the pairs of case unit 24 and flow passage unit 18, it is possible to enhance the rigidity by reinforcing the flow passage fitting faces of the two head units 13 with the insertion opening portions 62′ of the common base substrate 60, which are formed by partitioning the piezoelectric vibrators 15 in units of three piezoelectric vibrators 15 by the crosspieces 63. Thus, it is possible to further suppress compression deformation of the case units 24 and/or deformation of the flow passage units 18 caused by the action of the piezoelectric vibrators 15 of the vibrator units 16, each of which is contained and fixed in the accommodation chamber 32 of the case unit 24 in comparison with the case in which the insertion opening portions are formed in correspondence with each column of the piezoelectric vibrators 15.

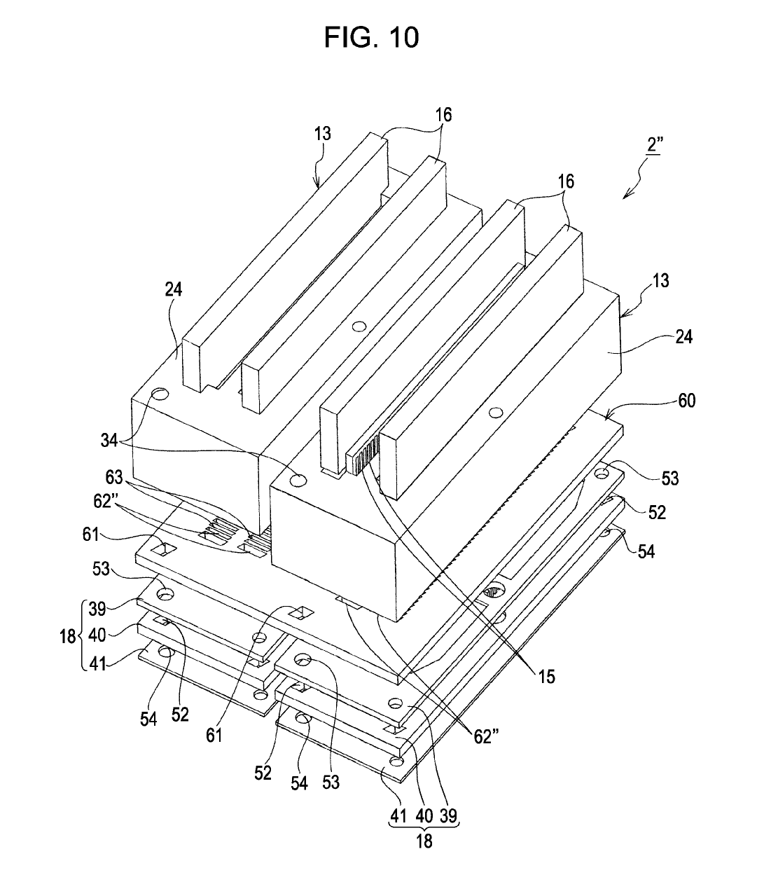

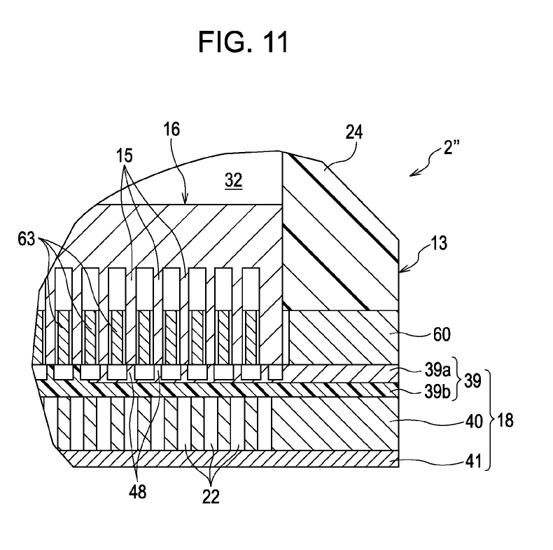

In addition, in a recording head 2″, as shown in FIG. 10 and FIG. 11, insertion opening portions 62″ of the common base substrate 60 are partitioned by the crosspieces 63 to be formed with a size corresponding to one piezoelectric vibrator 15. In this manner, in a state where each piezoelectric vibrator 15 is inserted into the corresponding insertion opening portion 62″, it is possible to enhance the rigidity of the flow passage fitting faces of the case units 24 so that each of the piezoelectric vibrators 15 is uniformly surrounded. Note that the other configuration is the same as that of the above described recording head 2 and, therefore, the description will not be repeated.

According to the recording head 2″, by positioning the two head units 13 using the reference positioning holes 61 of the common base substrate 60 as a reference, it is possible to position and assembly the two head units with high accuracy, and by interposing the common base substrate 60 between the pairs of case unit 24 and flow passage unit 18, it is possible to enhance the rigidity by reinforcing the flow passage fitting faces of the case units 24 with the insertion opening portions 62″ that are formed by partitioning the piezoelectric vibrators 15 of the common base substrate 60 one by one by the crosspieces 63. Thus, it is possible to suppress compression deformation of the case units 24 and/or deformation of the flow passage units 18 caused by the action of the piezoelectric vibrators 15 of the vibrator units 16, each of which is contained and fixed in the accommodation chamber 32 of the case unit 24. Particularly, by partitioning the insertion opening portions 62″ in units of the piezoelectric vibrator 15, the rigidity of the piezoelectric vibrators 15 becomes uniform. Thus, in comparison with the case in which the insertion opening portions 62′ are partitioned in units of a plurality of the piezoelectric vibrators 15, it is possible to suppress variation in discharge characteristics and make the discharge characteristic be uniform.

In the above described common base substrate 60, in order to enhance the flow passage fitting faces of the flow passage units 18 of the case units 24, it is desirable that the common base substrate 60 is formed of a material having a higher Young's modulus than each case unit 24 made of plastic. Thus, the common base substrate 60 may be formed by performing anisotropic etching on a silicon substrate (silicon wafer), which is a kind of crystalline base material, or may be, for example, formed of another material, such as stainless steel (SUS).

According to the above recording head, the common base substrate 60 is interposed between the plurality of pairs of case unit 24 and flow passage unit 18 and connects the plurality of pairs of case unit 24 and flow passage unit 18, it is possible to position and assemble the plurality of head units 13 using the common base substrate 60 as a reference. Thus, in comparison with the case in which positioning is made at the outer portion of the case unit 13, it is possible to perform positioning with the component that is located adjacent to the nozzle openings 19 and also possible to perform positioning with high accuracy and assembling. In addition, the pair of case unit 24 and flow passage unit 18, which form each of the units 13, may also be assembled on both sides with respect to the common base substrate 60 to thereby perform positioning with high accuracy.

In addition, at least two reference positioning holes 61 are formed for positioning each pair of case unit 24 and flow passage unit 18 on the common base substrate 60 so that each case unit 24 is located in correspondence with the flow passage unit 18, and the case unit 24 and the flow passage unit 18 are fixed at positions corresponding to the reference positioning holes 61. Thus, it is possible to perform positioning with high accuracy. In addition, at least two reference positioning holes 61 of the common base substrate 60 are arranged so as to overlap the positioning holes 34 of each case unit 24 and the positioning holes 52 of each flow passage unit 18. Thus, by overlapping the positioning holes each other, it is possible to easily perform positioning with high accuracy.

In addition, by forming the common base substrate 60 using a silicon substrate, it is possible to form the common base substrate with high accuracy by performing an etching process on the silicon substrate, and also possible to form each reference positioning hole 61 with high accuracy.

In addition, because the thickness of the common base substrate 60 is smaller than the length of the free end portion of each piezoelectric vibrator 15, it is possible to arrange the common base substrate 60 without changing the length of flow passage in the flow passage unit 18 to each piezoelectric vibrator 15 and to each nozzle opening 19. In this manner, without changing the discharge characteristics, it is possible to assemble the units in a state where they are positioned with high accuracy.

In addition, the insertion opening portions 62 are formed in the common base substrate 60, and the free end portions of the piezoelectric vibrators 15 located at positions corresponding to the diaphragm portions 48 of each flow passage unit 18 are inserted. Thus, without interfering with the piezoelectric vibrators 15, it is possible to arrange the common base substrate 60 and also possible to reinforce the surrounding of the diaphragm portions to thereby enhance the rigidity. In this manner, it is possible to improve the positioning accuracy, while, at the same time, it is possible to obtain the discharge with high response frequency and/or uniform discharge characteristics.

In the common base substrate 60, each of the insertion opening portions 62 is formed commonly to all the diaphragm portions in correspondence with each column of the diaphragm portions 48 of each flow passage unit 18, each of the insertion opening portions 62″ is formed in a one to one correspondence with each diaphragm portion 48, or each of the insertion opening portions 62′ is formed commonly to a plurality of the adjacent diaphragm portions 48. Thus, without interfering with the piezoelectric vibrators 15, it is possible to arrange the common base substrate 60 and also possible to reinforce the surrounding of the diaphragm portions 48 with the insertion opening portions 62, 62′, or 62″ having respective sizes to thereby enhance the rigidity. Moreover, it is possible to further enhance the rigidity and uniformly reinforce the surrounding of the diaphragm portions 48 when each of the insertion opening portions is reduced to the insertion opening portion 62″ having a size corresponding to the size of one piezoelectric vibrator 15.

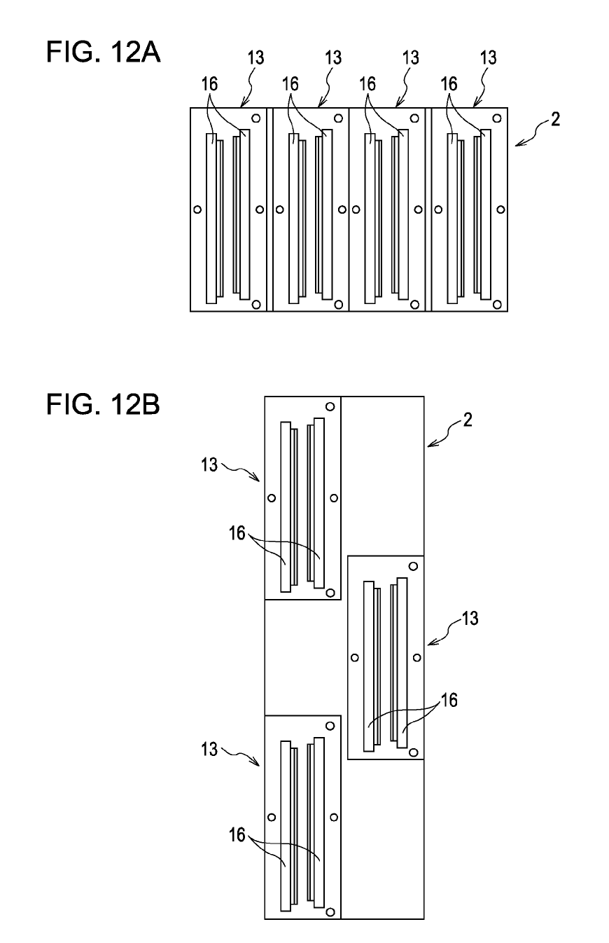

Incidentally, the aspects of the invention are not limited to the above described embodiments, but they may be modified into various alternative embodiments on the basis of the scope of the appended claims. In the above described embodiments, the case in which the recording head 2, 2′, or 2″ is provided with two head units 13 is described; however, as shown in FIG. 12A and FIG. 12B, a recording head may be configured to include multi-heads in which a plurality of head units 13 are arranged and to perform discharging from a plurality of columns of nozzle openings. The recording head may include, for example, four head units 13 that are arranged in a direction perpendicular to a nozzle array to form eight columns of heads or may include a plurality of head units 13 that are arranged in a zigzag manner in a nozzle array direction to form a line head. In any cases, by performing assembling using the reference positioning holes formed in one piece of common base substrate as a reference, it is possible to perform positioning and assembling with high accuracy.

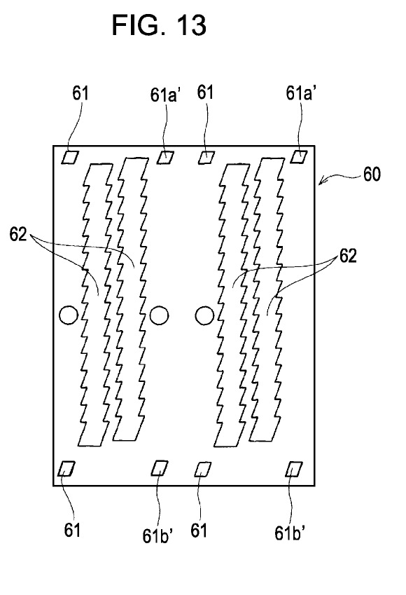

Note that, in the above described embodiments, when the accuracy of positioning holes (the accuracy of position or shape) of the common base substrate 60 is sufficiently ensured, it is applicable that, as shown in FIG. 13, positioning holes 61′ (61a′, 61b′) are formed at positions corresponding to two reference holes 52 located on the other long side of each flow passage substrate 40 on the common base substrate 60, and, using the positioning holes 61a′, 61b′, the flow passage units 18 and the common base substrate 60 are integrated and, after that, using the reference positioning holes 61, the case units 24 and the common base substrate 60 are bonded. In this case, the dimension of these reference positioning holes 61 are set larger than the reference holes 52 of each flow passage substrate 40. In addition, one pair of positioning holes 61a′ are formed in a rhombic shape having four sides of equal length, and the other pair of positioning holes 61b′ are set in parallelogram oblong holes. That is, the positioning holes 61a′ each are formed in a shape shown in FIG. 6A, and the positioning holes 61b′ each are formed in a shape shown in FIG. 6B.

In addition, the aspects of the invention are not limited to the recording head of the above described printer, but they may also be applied to other liquid ejecting heads. For example, the aspects of the invention may be applied to a display manufacturing device that manufactures a color filter of a liquid crystal display, or the like, an electrode manufacturing device that forms an electrode of an organic EL (Electro Luminescence) display, an FED (field emission display), or the like, and a chip manufacturing device that manufactures a biochip, or the like.

What is claimed is:

1. A liquid ejecting head comprising:
a flow passage unit that includes:
a liquid flow passage that at least includes a pressure chamber that communicates with a nozzle opening; and
a diaphragm portion that varies a volume of the pressure chamber;
a vibrator unit that inlucdes a piezoelectric vibrator that displaces the diaphragm portion;
a case unit that accommodates the vibrator unit; and
a common base substrate that connects a plurality of pairs of the case unit and the flow passage unit, wherein the common base substrate is fixed between the plurality of pairs of the case unit and the flow passage unit.

2. The liquid ejecting head according to claim 1, wherein
the common base substrate has at least two reference positioning holes that position a corresponding one of the pairs of the case unit and the flow passage unit, wherein
each of the case unit and the flow passage unit is fixed at positions corresponding to the at least two reference positioning holes.

3. The liquid ejecting head according to claim 2, wherein positioning holes of the case unit overlap positioning holes of the flow passage unit.

4. The liquid ejecting head according to claim 1, wherein the common base substrate is formed of a silicon substrate.

5. The liquid ejecting head according to claim 1, wherein the thickness of the common base substrate is set smaller than the length of a free end portion of each piezoelectric vibrator.

6. The liquid ejecting head according to claim 1, wherein the common base substrate has insertion opening portions, each of which is located at a position corresponding to the diaphragm portion of each flow passage unit, wherein a free end portion of each piezoelectric vibrator is insertable through each insertion opening portion.

7. The liquid ejecting head according to claim 1, wherein
each flow passage unit has a plurality of the diaphragm portions that are provided in a column in correspondence with a plurality of the pressure chambers, respectively, and wherein
the common base substrate has insertion opening portions, each of which is common to all the diaphragm portions in the same column in correspondence with each column of the diaphragm portions of each flow passage unit.

8. The liquid ejecting head according to claim 1, wherein
each flow passage unit has a plurality of the diaphragm portions that are provided in a column in correspondence with a plurality of the pressure chambers, respectively, and wherein
the common base substrate has a plurality of insertion opening portions in a one to one correspondence with each of the diaphragm portions of each flow passage unit.

9. The liquid ejecting head according to claim 1, wherein
each flow passage unit has a plurality of the diaphragm portions that are provided in a column in correspondence with a plurality of the pressure chambers, respectively, and wherein
the common base substrate has a plurality of insertion opening portions, each of which is common to and in correspondence with a plurality of the diaphragm portions that are located adjacent to one another in each flow passage unit.
